(19) United States
(12) Patent Application Publication
(10) Pub. No.: US 2026/0338532 A1
(43) Pub. Date: Oct. 29, 2026

(54) DEVICE AND METHOD FOR MEASURING A MISALIGNMENT BETWEEN THE AXES OF AT LEAST TWO CYLINDRICAL ORIFICES BELONGING TO TWO ADJACENT COMPONENTS

(71) Applicants: AIRBUS (S.A.S.), Blagnac (FR); AIRBUS OPERATIONS (S.A.S.), Toulouse (FR)

(72) Inventors: Xavier MATHEIS, Toulouse (FR); David COLMAGRO, Colomiers (FR)

(21) Appl. No.: 19/658,008

(22) Filed: Apr. 24, 2026

(30) Foreign Application Priority Data
Apr. 25, 2025 (FR) FR2504408

(51) Int. Cl. G01B 5/25; G01D 7/00

(52) U.S. Cl. CPC G01B 5/25; G01D 7/002

(57) ABSTRACT

A device including a positioning piece having a cylindrical portion inserted into a first cylindrical orifice, and a positioning plate inserted into the second cylindrical orifice, two pivoting arms which are angularly parted from one another under the action of a spring so as to come into contact with the internal surface of the second cylindrical orifice, and a rotary indicator hand that rotates according to the pivoting of the pivoting arms with respect to a dial provided with at least one scale representing the values of at least one parameter indicative of misalignment between the two cylindrical orifices. The device thus enables simple and precise measurement of the value of at least one parameter indicative of a misalignment, and possibly using this value to perform corrective operations in order to correct the misalignment during the assembly of the two components.

### CROSS REFERENCE TO RELATED APPLICATION

This application claims priority to French Application Number FR 2504408, filed Apr. 25, 2025, the entire contents of which is hereby incorporated by reference.

### TECHNICAL FIELD

The present invention relates to a device and to a method for measuring a misalignment between the axes of at least two cylindrical orifices belonging to two adjacent components.

### BACKGROUND

More specifically, although not exclusively, the present invention applies to the assembling of structural components or elements of an aircraft, notably a transport airplane.

When two components are being assembled, misalignments may arise between the axes of at least two cylindrical orifices belonging to the two components that are to be assembled, for example between a clevis and a mounting lug that collaborate.

In order to compensate for such errors it is known practice to use eccentric bushings.

By way of example, in order to assemble a vertical empennage of an aircraft, there is a procedure for mounting eccentric bushings for the vertical empennage, which entails manually rotating the eccentric bushings until concentricity is achieved such that that pins can be fitted.

In order to assemble a keel beam to the fuselage of the aircraft, the same type of manual operations need to be performed, namely the various eccentric bushings (or pieces) need to be rotated in order to find the correct angular position that enables the eccentric bushings (or pieces) to be fully inserted.

In both of the preceding examples, for which the misalignment between the cylindrical orifices concerned is unknown, the manual operations, some of which need to be performed without direct sight of the operation while it is being performed, are the source of quality issues, lead to unproductive workload and may entail specific training of the operators.

There is therefore a need to have a solution for measuring a misalignment between at least two cylindrical orifices (which are intended to be arranged coaxially) belonging to adjacent components that are to be assembled with one another.

### SUMMARY

The present invention has the objective of proposing a solution for meeting the aforementioned need. It relates to a device for measuring a misalignment between the axes of at least two cylindrical orifices belonging to two adjacent components, the two orifices being arranged so that they are coaxial.

According to the invention, said device comprises at least:
a positioning piece comprising a cylindrical portion configured to be able to be inserted into a first of said cylindrical orifices while being in pivoting and sliding contact therewith, and a positioning plate connected to the cylindrical portion and configured to be able to be inserted into the second cylindrical orifice while being in pivoting and sliding contact therewith;
two pivoting arms which are mounted on the positioning plate while being positioned symmetrically with respect to a bisector of a cylindrical sector of the positioning plate, the pivoting arms being able to be angularly parted from one another under the action of a spring so as to each come, via a free end, into contact with the internal surface of the second cylindrical orifice when the positioning plate is inserted into said second cylindrical orifice;
a rotary indicator hand configured to rotate according to the pivoting and to the angular separation of the two pivoting arms; and
a dial provided with at least one scale representing the values of a parameter indicative of misalignment between the two cylindrical orifices, the rotary indicator hand being able to move with respect to the scale of the dial, the pivoting arms, the indicator hand and the scale being configured so that the indicator hand indicates on the scale the value of the misalignment parameter when the cylindrical portion is inserted into the first cylindrical orifice and the positioning plate is inserted into the second cylindrical orifice with the two pivoting arms in contact with the internal surface of said second cylindrical orifice.

Thus, by virtue of the invention, a device is available that enables simple and precise measurement of the value of at least one parameter indicative of a misalignment between the axes of at least two cylindrical orifices belonging to two adjacent components. Knowledge of this value notably makes it possible to perform corrective operations in order to correct the misalignment, during the assembly of the two components.

In the context of the present invention, what is meant by two elements being in pivoting and sliding contact with one another is that the contact is both:
pivoting, one of the elements being able to rotate with respect to the other (namely about the other or inside the other depending on the radial positioning); and
sliding, one of the elements being in contact via the entirety of its (internal or external) surface with the (external or internal) surface of the other element, and this element being able to slide with respect to the other element (if not prevented from doing so by some other means).

In one preferred embodiment, each of said pivoting arms is provided with a finger and said device comprises a removable keeper configured to be able to hold the fingers together with the two pivoting arms in a close-together position.

Furthermore, advantageously, the dial is provided with two scales of values for the misalignment parameter, of which scales one represents values of the distance between the longitudinal axes of the two cylindrical orifices and the other represents values for the angular positioning of eccentric elements of a double-eccentric system that can be used for correcting the misalignment.

Moreover, advantageously, the positioning plate is provided with provided with a pointer which is arranged along the bisector of a cylindrical sector of the positioning plate.

In a simplified first embodiment, the positioning piece is configured so that the cylindrical portion can be inserted directly into the first cylindrical orifice, while being in pivoting and sliding contact therewith, and so that the positioning plate can be inserted directly into the second cylindrical orifice, while being in pivoting and sliding contact therewith.

Furthermore, in a preferred second embodiment, the device comprises at least two adapter rings; one of said adapter rings is intended, on the one hand, to be mounted in the first cylindrical orifice while being in pivoting and sliding contact therewith, and, on the other hand, to receive the cylindrical portion of the positioning piece while being in pivoting and sliding contact therewith, and the other adapter ring is intended, on the one hand, to be mounted in the second cylindrical orifice while being in pivoting and sliding contact therewith and, on the other hand, to receive the positioning plate of the positioning piece while being in pivoting and sliding contact therewith.

In addition, advantageously, each of said adapter rings is provided with an annular rim at one longitudinal end.

The present invention also relates to a method for measuring, using a measuring device such as the aforementioned one, a misalignment between the axes of at least two cylindrical orifices belonging to two adjacent components, the two cylindrical orifices being arranged so that they are coaxial.

According to the invention, said method comprises at least the following successive steps:
a mounting step of mounting the positioning piece by inserting the cylindrical portion of the positioning piece in a first of said cylindrical orifices so as to obtain pivoting and sliding contact and by inserting the positioning plate of the positioning piece in the second cylindrical orifice so as to obtain pivoting and sliding contact;
a release step of releasing the two pivoting arms, the two pivoting arms once released being parted from one another by the action of a spring until each one comes into contact, via a free end with the internal surface of the second cylindrical orifice, the angular separation of the two pivoting arms causing the rotary indicator hand to rotate; and
a reading step of reading, according to the position of the rotary indicator hand with respect to the scale of the dial, the value of the parameter indicative of misalignment between the two cylindrical orifices, which is indicated by the rotary indicator hand against the scale.

Advantageously, said method also comprises a step of fitting a keeper to hold the fingers together with the two pivoting arms in a close-together position and, during the release step, the keeper is removed from the two fingers.

The present invention further relates to a procedure for fitting a double-eccentric connecting system in at least two cylindrical orifices belonging to two adjacent components.

According to the invention, the procedure comprises at least one method such as the aforementioned one for measuring a misalignment between the axes of the two cylindrical orifices, and an installation step of installing the double-eccentric connecting system by angularly positioning the eccentrics in such a way as to correct the misalignment measured via said method.

### BRIEF DESCRIPTION OF THE DRAWINGS

The appended figures will make it easy to understand how the invention may be implemented. In these figures, identical references designate similar elements.

FIG. 1 is a perspective view of one particular embodiment of a measuring device.

FIG. 2 is an exploded perspective view of the measuring device of FIG. 1.

FIG. 3 is a partial perspective view showing the fitting of adapter rings into two orifices in two adjacent components, the misalignment between which two orifices is to be measured.

FIG. 4 is a schematic view in cross section showing a misalignment between two orifices of different diameters.

FIG. 5 is the block diagram of a measuring method.

FIG. 6 is a perspective view of an upper part of the measuring device of FIG. 1, to which a two-finger keeper is fitted.

FIG. 7 is a view of the measuring device from above, showing the values displayed on a dial of said measuring device.

FIG. 8 is a partial longitudinal section through a double-eccentric connecting system in place in a mounting lug and a clevis in order to correct a misalignment.

FIG. 9 is a schematic view in cross section showing the positioning of two eccentric elements.

FIG. 10 is the block diagram of a procedure for installing a double-eccentric connecting system.

### DETAILED DESCRIPTION

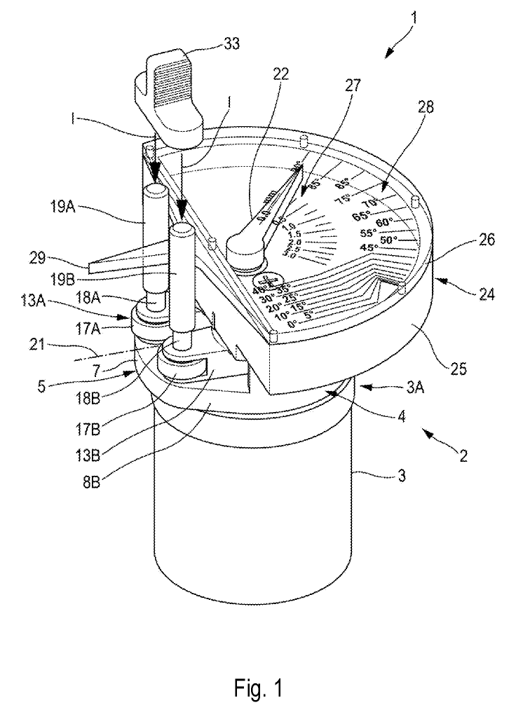

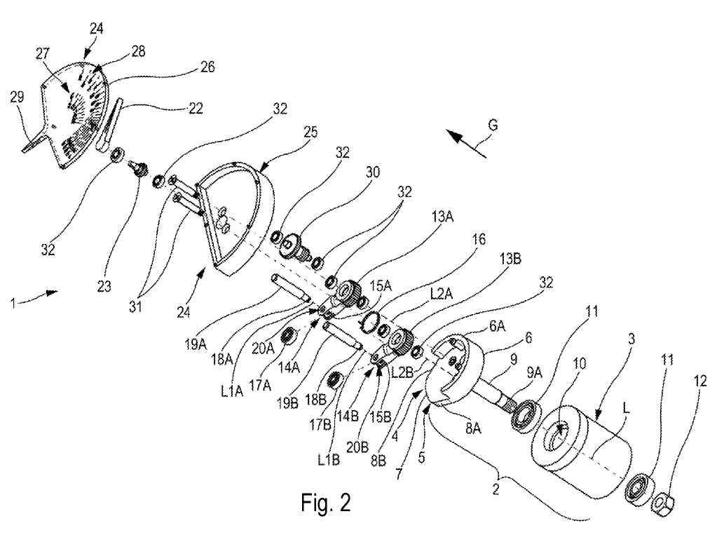

The measuring device (hereinafter "device 1") that illustrates the invention and depicted, schematically, in one particular embodiment in FIGS. 1 and 2, is intended to be used by an operator to measure a misalignment between the axes of at least two cylindrical orifices.

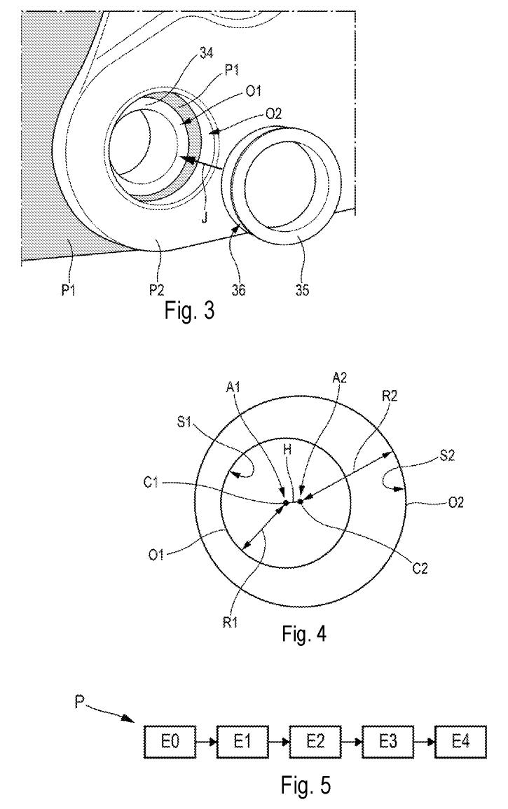

More specifically, it is intended to measure the misalignment between the axes of two cylindrical orifices O1 and O2 of two adjacent components P1 and P2, as schematically depicted in FIG. 3.

The two cylindrical orifices O1 and O2 (having radius R1 and R2 respectively (FIG. 4)) have different diameters, the diameter of the cylindrical orifice O1 being smaller than the diameter of the cylindrical orifice O2, and these two orifices are arranged so that they are, in theory, coaxial. Despite this arrangement that is intended to be coaxial, the two cylindrical orifices O1 and O2 are not perfectly coaxial and their longitudinal axes A1 and A2 are offset with respect to one another by a distance H, as illustrated in FIG. 4.

FIG. 4 is a schematic view in cross section showing the cylindrical orifices O1 and O2, of which the longitudinal axes A1 and A2, which are orthogonal to the plane of section depicted, pass through the centers C1 and C2 of these cylindrical orifices O1 and O2.

By way of illustration, the two components P1 and P2 may correspond to two structural elements of an aircraft, particularly of a transport airplane, that are to be assembled with one another.

The device 1 comprises a positioning piece 2, as depicted in FIGS. 1 and 2. This positioning piece 2 comprises:
a cylindrical portion 3 having a longitudinal axis L. The cylindrical portion 3 is configured to be able to be inserted in the cylindrical orifice O1 of the smaller diameter, as specified hereinbelow, while being in pivoting and sliding contact therewith; and
a positioning plate 4 which is connected to the cylindrical portion 3 at an upper end 3A (FIG. 1).

In the context of the present invention:
the terms "upper" and "lower" relating to the device 1 refer to relative positions in the direction indicated by an arrow G in FIG. 2, namely "upper" in the direction of the arrow G, and "lower" in the opposite direction to that of the arrow G;
the adjective "longitudinal" refers to the direction of the axis L (FIG. 2);
the adjectives "internal" and "external" are defined with respect to directions that are radial with respect to this axis L, namely in the case of "internal", closer to the axis L and, in the case of "external", further from the axis L; and
the adjective "transverse" refers to a plane orthogonal to the axis L.

The positioning plate 4 comprises a flat plate 5 arranged substantially orthogonal to the longitudinal axis L of the cylindrical portion 3. The positioning plate 4 is configured to be able to be inserted into the cylindrical orifice O2 while being in pivoting and sliding contact therewith, as specified hereinbelow.

As depicted in FIG. 2, the flat plate 5 comprises, along its contour:
a first part 6 shaped as an arc of a circle (of radius substantially equal to the radius R2 of the orifice O2), provided with a rim 6A;
a second part 7 shaped as an arc of a circle (of radius smaller than the radius R2 of the orifice O2), forming a circular sector; and
two straight edges 8A and 8B between the two circular-arc parts 5 and 7.

The positioning piece 2 comprises, under the positioning plate 4 (at the lower end thereof), a cylindrical tenon 9 having a threaded sector 9A at its free end. The tenon 9 is intended to be introduced into roller bearings 11 integrated into a cylindrical opening 10 (this being a central opening of longitudinal axis L) of the cylindrical portion 3.

The positioning plate 4 is held in place by a nut 12 screwed onto the threaded sector 9A of the tenon 9. The positioning plate 4 is thus pivotably connected to the cylindrical portion 3.

The device 1 also comprises two pivoting arms 13A and 13B which are mounted on the positioning plate 4. These two pivoting arms 13A and 13B can rotate about axes L2A and L2B that are parallel to the longitudinal axis L. The two pivoting arms 13A and 13B are arranged symmetrically with respect to a bisector 21 (FIG. 1) of the cylindrical sector 7 of the positioning plate 4.

The two pivoting arms 13A and 13B are angularly parted from one another by the action of a spring 16 (FIG. 2). The two pivoting arms 13A and 13B are able to be angularly parted such that they come into contact with the internal surface S2 (FIG. 4) of the cylindrical orifice O2 via a rolling bearing 17A, 17B when the positioning plate 4 is inserted into the cylindrical orifice O2, as specified hereinbelow.

As depicted in FIG. 2, the pivoting arm 13A comprises, at its free end 14A, a clevis 15A in which is mounted the rolling bearing 17A which rotates about a portion 18A of a finger 19A. The portion 18A for this purpose passes through openings 20A of the clevis 15A. The finger 19A is arranged along an axis L1A parallel to the longitudinal axis L.

Likewise, the pivoting arm 13B comprises, at its free end 14B, a clevis 15B in which is mounted the rolling bearing 17B which rotates about a portion 18B of a finger 19B. The portion 18B for this purpose passes through openings 20B of the clevis 15B. The finger 19B is arranged along an axis L1B parallel to the longitudinal axis L.

The device 1 also comprises a rotary indicator hand 22 configured to rotate according to the pivoting and to the angular separation of the two pivoting arms 13A and 13B, as indicated hereinbelow.

The rotary indicator hand 22 is mounted on a shaft 23. The rotary indicator hand 22 is installed inside a substantially semicircular housing 24. This housing 24 comprises a base 25 (provided with a rim) to which base a dial 26 is attached. The dial 26 is transparent so that the rotary indicator hand 22 can be seen through the dial 26. The dial 26 has at least one scale 27, 28.

In one particular embodiment, the shaft 23 that allows the rotary indicator hand 22 to rotate is provided with a gearwheel and is associated with a component 30 also provided with a gearwheel. The shaft 23 and the component 30 form a gearset able to generate a scaled movement (scaled by a scaling factor of, for example, 2 or 3) so that if the pivoting arms 13A and 13B move away from (or toward) one another by a given angle, the rotary indicator hand 22 rotates in one direction (or the other) by a scaled angle corresponding to this given angle multiplied by the scaling factor.

The rotary indicator hand 22 is able to move with respect to the scale 27, 28 of the dial 26. The scale 27, 28 displays of values of at least one parameter indicative of misalignment between the two cylindrical orifices.

In the example depicted in FIGS. 1, 2, 6 and 7, the dial 26 is provided with two scales 27 and 28 (of values of misalignment parameters). The scale 27 represents distance values (expressed in millimeters (mm)) for the distance between the longitudinal axes A1 and A2 of the two cylindrical orifices O1 and O2, and able to indicate the value of the distance H between the axes A1 and A2 (FIG. 4). The scale 28 represents angular values (expressed in degrees (°)) for the positioning of eccentric elements of a double-eccentric system used for correcting the misalignment, as specified hereinbelow.

Thus, the device 1 provides the operator with two types of values:
a distance value, indicating the distance H between the two axes A1 and A2 of the cylindrical orifices O1 and O2, for example in increments of 0.25 millimeters; and
an angular value, used for positioning eccentric elements.

The device 1 also provides a reference direction corresponding to the direction indicated by a pointer 29 of the dial 26. As depicted notably in FIGS. 1 and 2, the dial 26 is provided with a pointer 29 which is arranged along the bisector 21 of the cylindrical sector 7 of the positioning plate 4.

Moreover, the pivoting arms 13A and 13B, the rotary indicator hand 22 and the scale 27, 28 are configured so that the rotary indicator hand 22 indicates on the scale 27, 28 the value of the misalignment parameter when the device 1 is in place in the cylindrical orifices O1 and O2, namely when the cylindrical portion 3 is inserted into the cylindrical orifice O1 and the positioning plate 4 is inserted in the cylindrical orifice O2 with the two pivoting arms 13A and 13B in contact with the internal surface S2 of the cylindrical orifice O2.

FIG. 2 also depicts other components of the device 1, including screws 31 and rolling bearings (or rollers) 32.

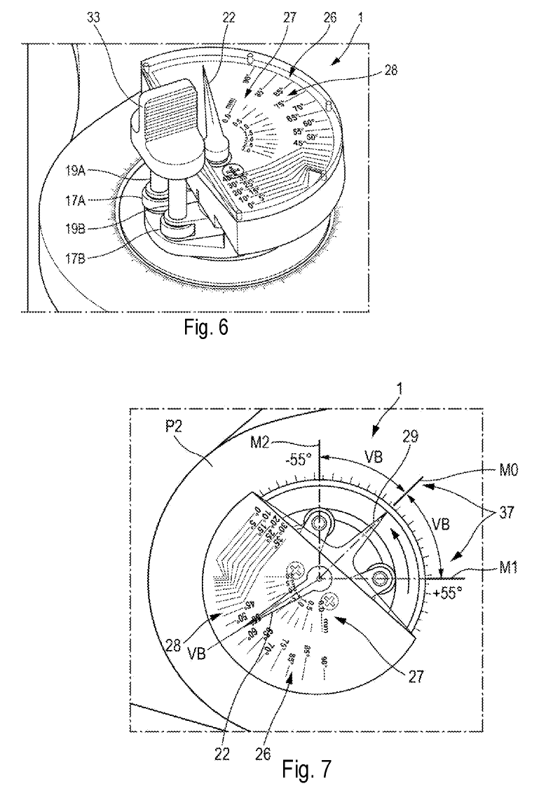

Moreover, the device 1 comprises a removable keeper 33 (FIGS. 1 and 6). This keeper 33 is configured to be able to hold the fingers 19A and 19B together with the two pivoting arms 13A and 13B in a close-together position, as depicted in FIG. 6.

In a simplified first embodiment (not depicted), the positioning piece 2 is configured such that:
the cylindrical portion 3 can be inserted directly into the cylindrical orifice O1 of the component P1, in pivoting and sliding contact therewith; and
the positioning plate 4 can be inserted directly into the cylindrical orifice O2 of the component P2, in pivoting and sliding contact therewith.

What is meant by two elements being in pivoting and sliding contact with one another is that the contact is both:
pivoting, which is to say that one of the elements is able to rotate with respect to the other (namely about the other or inside the other depending on the radial positioning); and
sliding, which is to say that one of the elements is in contact via the entirety of its internal or external surface with the external or internal surface of the other element and is able to slide with respect to this other element (if not prevented from doing so by some other means).

Furthermore, in a preferred second embodiment depicted in FIG. 3, the device 1 comprises adapter rings 34 and 35.

The adapter ring 34 is intended both:
to be mounted in the cylindrical orifice O1 (FIG. 4) of the component P1 in pivoting and sliding contact with the internal surface S1 thereof; and
to receive the cylindrical portion 3 of the positioning piece 2 in pivoting and sliding contact.

Likewise, the adapter ring 35 is intended both:
to be mounted in the cylindrical orifice O2 (FIG. 4) of the component P2 in pivoting and sliding contact with the internal surface S2 thereof; and
to receive the positioning plate 4 of the positioning piece 2 in pivoting and sliding contact.

As a result, thanks to such adapter rings 34 and 35, the device 1 can be used for orifices of different and various diameters. In order to do this, use should be made of a suitable set of adapter rings 34 and 35 for which, in each instance, the outside diameter is matched to the diameter of the orifice O1, O2 of the component P1, P2 and the inside diameter is matched to the outside diameter of the corresponding part (cylindrical portion 3 or positioning plate 4) of the positioning piece 2 of the device 1. Each adapter ring 34, 35 is such that its external and internal surfaces are coaxial in cross section.

This second embodiment makes use of the (measuring) device 1 extremely flexible.

In addition, in one particular embodiment, each of the adapter rings 34 and 35 is provided with an annular rim 36 (FIG. 5) at one longitudinal end. This annular rim 36 serves to prevent translational movement of the adapter ring as it is being installed, in the direction illustrated by an arrow J in FIG. 3 in the case of the adapter ring 35.

The device 1 as described hereinabove can be used by an operator to implement a (measuring) method P depicted in FIG. 5. The purpose of this method P is to measure, using said device 1, a misalignment between the axes A1 and A2 of at least two cylindrical orifices O1 and O2 (of different diameters) of two adjacent components P1 and P2, the two cylindrical orifices O1 and O2 being arranged coaxially.

In order to do this, the method P comprises at least the following successive steps:
a mounting step E1 of mounting the keeper 33 on the device 1 with a view to holding the fingers 19A and 19B together with the two pivoting arms 13A and 13B in a close-together position;
a fitting step E2 of fitting the positioning piece 2;
a release step E3 of releasing the two pivoting arms 13A and 13B; and
a reading step E4 of reading, off the scale 27, 28 of the dial 26, the value of the parameter indicative of misalignment between the two cylindrical orifices O1 and O2, as indicated by the rotary indicator hand 22 against the scale 27, 28.

The method P may also comprise a preliminary step E0 which is implemented (before steps E1 to E4) in instances in which:
the diameter of the cylindrical portion 3 of the positioning piece 2 is less than the diameter of the cylindrical orifice O1, so as to leave a clearance that does not allow sliding contact to be achieved; and/or
the diameter of the positioning plate 4 of the positioning piece 2 is less than the diameter of the cylindrical orifice O2, so as to leave a clearance that does not allow sliding contact to be achieved.

The preliminary step E0 is therefore implemented for the (aforementioned) preferred second embodiment for which the device 1 comprises at least two adapter rings 34 and 35 of appropriate sizes. The adapter ring 34 is such that it has an outside diameter that allows it to be mounted in the cylindrical orifice O1 in pivoting and sliding contact therewith, and an inside diameter that allows it to surround the cylindrical portion 3 of the positioning piece 2 in pivoting and sliding contact. In addition, the adapter ring 35 is such that it has an outside diameter that allows it to be mounted in the cylindrical orifice O2 in pivoting and sliding contact therewith, and an inside diameter that allows it to surround the positioning plate 4 of the positioning piece 2 in pivoting and sliding contact.

By contrast, the (aforementioned) preliminary step E0 is not implemented for the simplified first embodiment for which the positioning piece 2 is such that both:
the cylindrical portion 3 can be inserted directly into the cylindrical orifice O1 in pivoting and sliding contact therewith; and
the positioning plate 4 can be inserted directly into the cylindrical orifice O2 in pivoting and sliding contact therewith.

In the preliminary step E0, an operator fits a suitable set of adapter rings 34 and 35.

To do that, the operator inserts the adapter ring 34 into the cylindrical orifice O1 until its rim comes into contact with the component P1. Next, they insert the adapter ring 35, in the direction illustrated by the arrow J in FIG. 3, into the cylindrical orifice O2 until its rim 36 comes into contact with the component P2.

Thus, because of the larger inside diameter of the adapter ring 35, the device 1 can be inserted (in the direction of the arrow J in FIG. 3) in order to take the misalignment measurement.

The steps E1 to E4 will now be described in more detail. The steps E1 to E4 of the method P are implemented whatever the embodiment considered (namely with or without adapter rings 34 and 35).

The following description describes the fitting of the device 1 for an embodiment comprising adapter rings 34 and 35. Steps E1 to E4 are applied similarly when the device 1 is inserted directly into the cylindrical orifices O1 and O2.

In step E1 the operator fits the keeper 33 on the device 1 in order to hold the fingers 19A and 19B together with the two pivoting arms 13A and 13B in a close-together position.

To do that, the operator manually squeezes the fingers 19A and 19B toward one another and fits the keeper 33 in the direction illustrated by the arrows I in FIG. 1. The rotary indicator hand 22 therefore displays a value less than 0 on the scale 27 of the dial 26, as depicted in FIG. 6.

The keeper 33 ensures that the fingers 19A and 19B cannot knock against the edges of the adapter ring 35 while the device 1 is being inserted into the cylindrical orifices.

During the fitting step E2 that follows, the operator fits the positioning piece 2 of the device 1. To do that, they insert the cylindrical portion 3 of the positioning piece 2 into the cylindrical orifice O1 (the one with the smaller diameter) so as to obtain pivoting and sliding contact. They next insert the positioning plate 4 of the positioning piece 2 into the cylindrical orifice O2.

The purpose of the positioning plate 4 is to give the operator the correct angular position for inserting the device 1. The correct angular position is the position in which the positioning plate 4 can be fully inserted into the adapter ring 35. To achieve this, the operator rotates the device 1 until the positioning plate 4 can be completely inserted into the cylindrical orifice O2 and then pushes it in until it is stopped by the upper end 3A.

Next, in the release step E3 that follows, the operator releases the two pivoting arms 13A and 13B by removing the keeper 33 from the two fingers 19A and 19B. Once released, the two pivoting arms 13A and 13B are parted from one another by the action of the spring 16 (FIG. 2), until each one comes into contact, via its rolling bearing 17A, 17B, with the internal surface S2 (FIG. 4) of the cylindrical orifice O2. The angular separation of the two pivoting arms 13A and 13B causes the rotary indicator hand 22 to rotate.

In general, the two pivoting arms 13A and 13B separate until a first finger comes into contact with the interior surface of the adapter ring 35. Under the action of the spring 16, the entire device 1 therefore rotates on itself (thanks to the roller bearings 11) until the other finger likewise comes into contact with the interior surface of the adapter ring 35. The device 1 is then in its final position.

The rotary indicator hand 22 assumes an (angular) position corresponding to the angular separation of the two pivoting arms 13A and 13B in this final position.

The operator can then, in the reading step E4, read the value or values of the misalignment parameter or parameters. The operator can read, off the scale 27, 28 of the dial 26, the value of the parameter indicative of misalignment between the two cylindrical orifices O1 and O2, as indicated by the rotary indicator hand 22.

In the example of FIG. 7, on the transparent dial 26, the rotary indicator hand 22 is indicating, on the scale 27, a metric value of the order of 1.5 mm and, on the scale 28, an angular value of the order of 55°.

Thus, by virtue of the device 1 and of the method P, both as described hereinabove, a solution is available that enables simple and precise measurement of the value of at least one parameter indicative of a misalignment between the axes A1 and A2 of at least two cylindrical orifices O1 and O2 belonging to two adjacent components P1 and P2. Knowledge of this/these value/s notably makes it possible to perform corrective operations (for example appropriate angular positionings) in order to correct the misalignment, during the assembly of the two components P1 and P2.

The method P as described hereinabove, together with the results obtained, can be used in various applications.

In particular, the method can be used in a procedure M (FIG. 10) for installing a double-eccentric connecting system 40 in at least two cylindrical orifices belonging to two adjacent components.

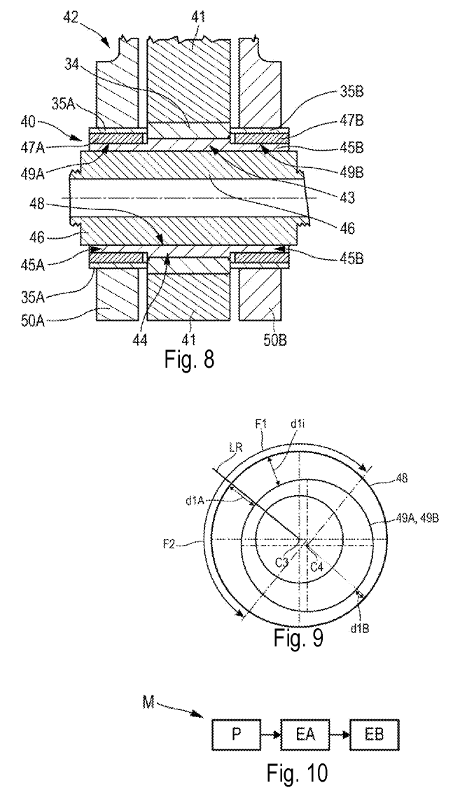

In the example depicted in FIG. 8, the system 40 is used to connect a mounting lug 41 to a clevis 42 provided with two branches 50A and 50B.

In one particular application, the system 40 is intended for connecting one end of a keel beam to part of the fuselage of the aircraft. In this particular application, a plurality of systems 40 are used. For each system 40, the mounting lug is secured to the fuselage part and the clevis is secured to the end of the keel beam.

As partially depicted in FIG. 8, the system 40 comprises:
a main sleeve 43 comprising a central portion 44 intended to be inserted in an adapter ring 34 mounted in the mounting lug 41. The central portion 44 has, in cross section, a circular external surface having a first diameter. The main sleeve 43 also comprises two end portions 45A and 45B, connected to the central portion 44, longitudinally one on each side of the central portion 44. The external surfaces of the two end portions 45A and 45B have in cross section a circular shape each having the same second diameter. This second diameter is different than said first diameter and the centers of said circular external surfaces of the two end portions 45A and 45B are offset with respect to the center of the circular external surface of the central portion 44;
an internal sleeve 46 which is housed in the main sleeve 44, its external surface being in contact with an internal surface of the main sleeve 44; and
two eccentric bushings 47A and 47B. Each of the eccentric bushings 47A and 47B is mounted on one of the end portions 45A, 45B with a circular internal surface in contact with the circular external surface of the corresponding end portion and is inserted in an adapter ring 35A, 35B mounted in a branch 50A, 50B of the clevis 42. Each of said eccentric bushings 47A and 47B has an external surface that is circular in cross section and the center of which is offset with respect to the center of its circular internal surface.

The system 40 thus comprises two pairs of eccentric elements, namely the eccentric elements 48 and 49A and the eccentric elements 48 and 49B. The eccentric element 48 is obtained as a result of the offset between the corresponding end portion 45A, 45B and the central portion 44 of the main sleeve 4, and the eccentric element 49A, 49B is obtained as a result of the offset between the internal and external surfaces of the corresponding eccentric bushing 47A, 47B.

These two eccentric elements 48 and 49A (or 49B) make it possible, by suitable angular-rotation positioning of the main sleeve 43 and therefore of the central portion 44 in the adapter ring 34, which is obtained by rotating the main sleeve 43, and by angularly positioning the eccentric bushings 47A and 47B with respect to the main sleeve 43, this being obtained by rotating the eccentric bushings 47A and 47B with respect to the main sleeve 43, to compensate for a misalignment (or an alignment error) between the through-orifice of the mounting lug 41 and the through-orifices of the clevis 42.

As depicted by way of illustration in FIG. 9, the distance d1i between the external surface of the eccentric element 48 and the external surface of the eccentric element 49A, 49B in the transverse plane, varies according to their angular positions. FIG. 9 shows a reference line LR passing through the respective centers C3 and C4. This reference line LR is such that along said reference line segment LR, at one end the distance d1A between the external surfaces is the longest and, at the other end, the distance d1B between the external surfaces is the shortest. Starting from the relative angular positions of FIG. 9, and rotating an element in the direction illustrated by an arrow F1 (or in the opposite direction illustrated by an arrow F2), the distance d1i decreases from the distance d1A to the distance d1B.

In order to install the system 40, the procedure M comprises:
the method P as described hereinabove, for measuring a misalignment between the axes of the two cylindrical orifices;
a marking-out step EA; and
an installation step EB.

In the installation step EB, an operator fits the double-eccentric connecting system 40 with the eccentric elements 48, 49A and 49B angularly positioned in such a way as to correct the misalignment measured by the method P.

In this procedure M, during implementation of the method P, after the step E4, the next step is the marking-out step EA which comprises the following operations.

As depicted in FIG. 7, the pointer 29 then indicates a direction relative to a median position. A mark M0 is made on the surface 37 of the component P2 at this median position.

In addition, the indicator hand 22 indicates VB as angular value. In the example of FIG. 7, the indicator hand 22 indicates 55°, by way of angular value V. This angular value VB corresponds to half the total misalignment between the eccentric elements.

Starting from the mark M0, two other marks M1 and M2 are made on the surface 37 of the component P2, these being a first mark M1 at an angle corresponding to said angular value VB (55°) in the clockwise direction from the mark M0 and a second mark M2 corresponding to said angular value VB (55°) in the counterclockwise direction from the mark M0, as depicted in FIG. 7.

At this stage, the (measuring) device 1 can be removed and the operator can position the eccentric elements 48, 49A (or 49B) using the marks M0, M1 and M2, during the installation step EB.

More specifically, in order to easily orient the eccentric elements, the operator uses a reference line for each of the eccentric elements 48, 49A (or 49B), such as the reference line LR of FIG. 9, preferably a cutout which is generally present on each of the eccentric elements, the main purpose of such a cutout being to immobilize the eccentric element once it is in place.

During insertion of the main sleeve 43 and of an eccentric bushing 47A, 47B, the operator positions the reference line of one of the eccentric elements, for example of the main sleeve 43, on the mark M1 (at +55°) and the reference line of the other eccentric element, for example of the eccentric sleeve 47A, 47B on the mark M2 (at -55°). They then hold all the elements of the system 40 together using conventional means (which have not been depicted).

1. A device for measuring a misalignment between the axes (A1, A2) of at least two cylindrical orifices (O1, O2) belonging to two adjacent components (P1, P2), the two cylindrical orifices (O1, O2) being arranged so that they are coaxial,
comprising:
a positioning piece comprising a cylindrical portion configured to be inserted into a first (O1) of said cylindrical orifices (O1, O2) while being in pivoting and sliding contact therewith, and a positioning plate pivotably connected to the cylindrical portion and configured to be able to be inserted into the second cylindrical orifice (O2) while being in pivoting and sliding contact therewith;
two pivoting arms which are mounted on the positioning plate while being positioned symmetrically with respect to a bisector of a cylindrical sector of the positioning plate, the pivoting arms being able to be angularly parted from one another under the action of a spring so as to each come, via a free end, into contact with the internal surface (S2) of the second cylindrical orifice (O2) when the positioning plate is inserted into said second cylindrical orifice (O2);
a rotary indicator hand configured to rotate according to the pivoting and to the angular separation of the two pivoting arms;
a dial including at least one scale representing the values of at least one parameter indicative of misalignment between the two cylindrical orifices (O1, O2), the rotary indicator hand configured to move with respect to the scale of the dial; and,
wherein the pivoting arms, the rotary indicator hand and the scale are configured so that the rotary indicator hand indicates on the scale the value of the misalignment parameter when the cylindrical portion is inserted into the first cylindrical orifice (O1) and the positioning plate is inserted into the second cylindrical orifice (O2) with the two pivoting arms in contact with the internal surface (S2) of said second cylindrical orifice (O2).

2. The device as claimed in claim 1, wherein each of said pivoting arms is provided with a finger, and wherein said device comprises a removable keeper configured to be able to hold the fingers together with the two pivoting arms in a close-together position.

3. The device as claimed in claim 1, wherein the dial comprises two scales of values for the misalignment parameter, wherein one of the scales represents values of the distance between the longitudinal axes (A1, A2) of the two cylindrical orifices (O1, O2) and the other of two scales represents values for the angular positioning of eccentric elements of a double-eccentric system that can be used for correcting the misalignment.

4. The device as claimed in claim 1, wherein the dial is provided with a pointer which is arranged along the bisector of the cylindrical sector of the positioning plate.

5. The device as claimed in claim 1, wherein the positioning piece is configured so that the cylindrical portion can be inserted directly into the first cylindrical orifice, while being in pivoting and sliding contact therewith, and so that the positioning plate can be inserted directly into the second cylindrical orifice , while being in pivoting and sliding contact therewith.

6. The device as claimed in claim 1, wherein the device comprises at least two adapter rings, wherein one of said adapter rings is configured, on the one hand, to be mounted in the first cylindrical orifice (O1) while being in pivoting and sliding contact therewith, and, on the other hand, to receive the cylindrical portion of the positioning piece while being in pivoting and sliding contact therewith, and wherein the other adapter ring is configured, on the one hand, to be mounted in the second cylindrical orifice (O2) while being in pivoting and sliding contact therewith and, on the other hand, to receive the positioning plate of the positioning piece while being in pivoting and sliding contact therewith.

7. The device as claimed in claim 6, wherein each of said adapter rings further includes an annular rim at one longitudinal end.

8. A method for measuring using the measuring device as claimed in claim 1, comprising:
a mounting step (E2) of mounting the positioning piece by inserting the cylindrical portion of the positioning piece in a first (O1) of said cylindrical orifices (O1, O2) so as to obtain pivoting and sliding contact and by inserting the positioning plate of the positioning piece in the second cylindrical orifice (O2) so as to obtain pivoting and sliding contact;
a release step (E3) of releasing the two pivoting arms, the two pivoting arms once released being parted from one another by the action of a spring until each one comes into contact, via a free end with the internal surface (S2) of the second cylindrical orifice (O2), the angular separation of the two pivoting arms causing the rotary indicator hand to rotate; and
a reading step (E4) of reading, according to the position of the rotary indicator hand with respect to the scale of the dial, the value of the parameter indicative of misalignment between the two cylindrical orifices (O1, O2), which is indicated by the rotary indicator hand against the scale.

9. The method as claimed in claim 8, further comprising a step (E1) of fitting a keeper to hold the two fingers together with the two pivoting arms in a close-together position, and wherein during the release step (E3) the keeper is removed from the two fingers.

10. The method as claimed in claim 8, wherein the steps of mounting, releasing, and reading are consecutive.

11. A procedure for fitting a double-eccentric connecting system in at least two cylindrical orifices belonging to two adjacent components, wherein said procedure comprises at least one method (P) as claimed claim 8 for measuring a misalignment between the axes (A1, A2) of the two cylindrical orifices (O1, O2), and an installation step (EB) of installing the double-eccentric connecting system by
angularly positioning the eccentric elements in such a way as to correct the misalignment measured via said method (P).
